(19) United States
(12) Patent Application Publication
(10) Pub. No.: US 2016/0292400 A1
(43) Pub. Date: Oct. 6, 2016

(54) SD CARD LICENSE MECHANISM

(71) Applicant: Honeywell International Inc., Morristown, NJ (US)

(72) Inventors: David Thompson, Rockville, VA (US); Daniel Giorgis, Glen Allen, VA (US)

(21) Appl. No.: 14/673,705

(22) Filed: Mar. 30, 2015

(51) Int. Cl. G06F 21/12; G06F 21/10

(52) U.S. Cl. CPC G06F 21/123; G06F 21/105; G06F 2221/2111; G06F 2221/0704

(57) ABSTRACT

A system and approach for providing software device or secure digital (SD) cards for computing devices. An SD card may be programmed with a unique card identification register (CID) value during a manufacture of the card. The CID value cannot necessarily be changed by a card host such as a computing device. A securely signed license may be generated with the CID value (or a hash of the CID value) as part of the license's plaintext. The license may be stored on the card with the CID value. The card may be installed in virtually any computing device that supports the card. The card may be easily removed from the computing device and installed in another computing device or be placed in a storage mechanism. The license may be treated as portable like the card.

### BACKGROUND

The present disclosure pertains to circuit cards and particularly to read-write memory cards associated with computers.

### SUMMARY

The disclosure reveals a system and approach for providing software device or secure digital (SD) cards for computing devices. An SD card may be programmed with a unique card identification register (CID) value during a manufacture of the card. The CID value cannot necessarily be changed by a card host such as a computing device. A securely signed license may be generated with the CID value, or a hash of the CID value, as part of the license's plaintext. The securely signed license's plaintext cannot be modified without detection. The license may be stored on the card with the CID value. The card may be installed in virtually any computing device that supports the card. The card may be easily removed from the computing device and installed in another computing device or be placed in a storage mechanism. The license may be treated as portable like the card.

### BRIEF DESCRIPTION OF THE DRAWING

FIG. 1 is a diagram of an approach for developing an SD card;

FIG. 2 is a diagram of implementation details of an SD card license mechanism; and

FIG. 3 is a diagram of an interaction of the SD card with one or more host computing devices.

### DESCRIPTION

The present system and approach may incorporate one or more processors, computers, controllers, user interfaces, wireless and/or wire connections, and/or the like, in an implementation described and/or shown herein.

This description may provide one or more illustrative and specific examples or ways of implementing the present system and approach. There may be numerous other examples or ways of implementing the system and approach.

A securely signed (software) license that incorporates a unique and immutable hardware characteristic of a computing device is not necessarily portable when the hardware or subsystem providing that characteristic cannot be easily removed. The license will not necessarily function on any other computing device.

Commercially, when a computing device has a failure requiring hardware replacement, the securely signed (software) license may need to be reproduced for, and installed on, the replacement device. This may be burdensome for the licensing body and the end user of the device.

Current mechanisms to provide this unique and immutable hardware characteristic may include read only memories (ROMs) that are permanently or semi-permanently attached to the computing device (with a soldered or equivalent process).

An SD card standard may provide for a unique card identification register (CID) value that is programmed during card manufacturing and cannot necessarily be changed by SD card hosts.

If a securely signed (software) license is stored on an SD card, that SD card may be installed in any computing device with SD card support. SD cards may be easily removable and portable, unlike ROM devices.

When a securely signed (software) license is generated using a card identification register (CID) value, or a hash of the CID value, as part of the license's plaintext and that license is stored on the SD Card with that CID value, that license may be portable and be used on other computing devices since the SD card can be removable. An example of a hash may be a Pearson hashing. Other hash functions may be used.

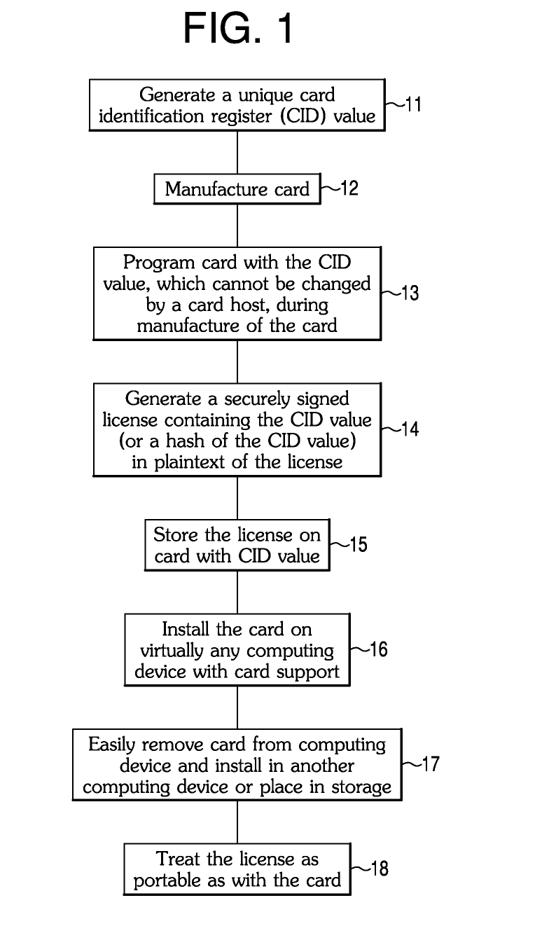

FIG. 1 is a diagram of an approach for development and use of a portable SD or other card. In symbol 11, a unique card identification register value may generated with a process that checks for and designs a format relative to the CID value. The card may be manufactured at symbol 12 and programmed during its manufacture with the generated CID value which cannot necessarily be changed by a card host, as indicated by symbol 13.

A unique value may be one or less than one out of a hundred values. A securely signed license may be generated with the CID value, or a hash of the CID value, as part of the license's plaintext noted in symbol 14. The license, as shown by symbol 15, may be stored on the card with the CID value. Symbol 16 indicates that the card may be installable on virtually any computing device that can support the card. One may easily remove the card from the computing device and install the card in another computing device or place the card in storage, as noted in symbol 17. The license may be treated as being portable in the same manner that the card is portable according to symbol 18.

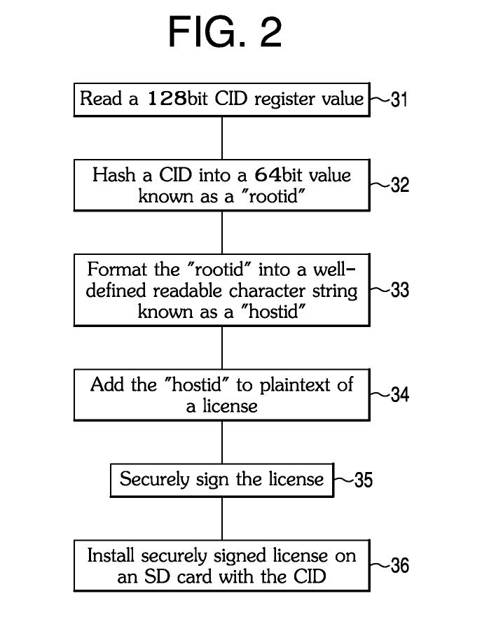

FIG. 2 is a diagram of implementation details of the present SD card license mechanism that may incorporate read the 128 bit CID register value at symbol 31, hash the CID into a 64 bit value known as a “rootid” at symbol 32, format the “rootid” into a well-defined readable character string known as a “hostid” at symbol 33, add the “hostid” to plaintext of a license at symbol 34, securely sign the license at symbol at symbol 35, and install the securely signed license on a SD card with the CID at symbol 36. The securely signed license's plaintext containing the “hostid” derived from a unique CID, cannot necessarily be modified without detection.

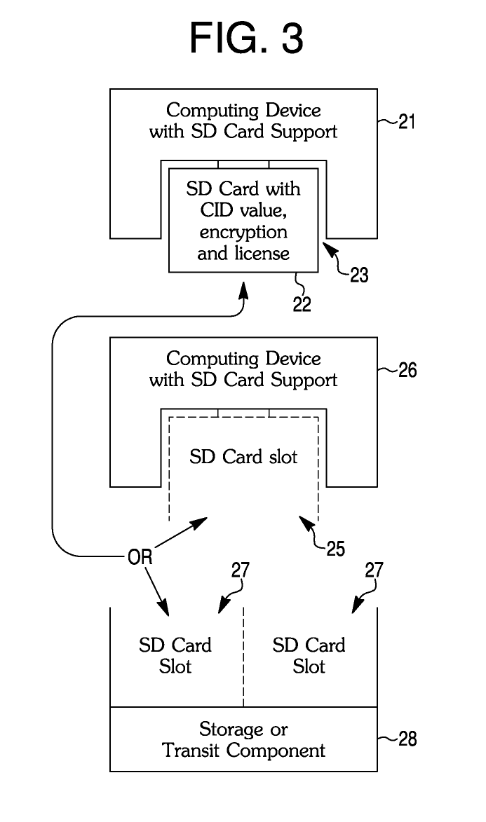

FIG. 3 is a diagram showing a computing device 21 having an SD card 22 inserted in a slot 23 of computing device 21. Being able to support card 22 may be needed by device 21. Card 22 may be easily removed from device 21 and inserted in a slot 25 of another computing device 26 that can support card 22. On the other hand, card 22 may instead be placed in a card slot 27 of a storage or a transit component 28. Card slot 27 and corresponding storage or transit component 28 may provide portability of the license and the card.

To recap, a card system may incorporate a software device or secure digital (SD) card having a unique card identification register value that is programmed into the SD card during a manufacturing of the secure digital card, and a license stored on the SD card with the card identification register value. The license may be generated using the card identification register value, or a hash of the card identification register value, as part of a plaintext of the license in a secure signing process. The license may be a secure software license. The term “unique” may mean one or less than one out of one hundred.

The SD card may be removable from one computing device and installable in another computing device provided that the SD card is supported by the computing device.

The card identification register value may be virtually unchangeable by a computing device that is a host for the SD card.

The license may be portable from one computing device to another computing device.

An approach for providing a card, may incorporate manufacturing a card, generating a unique card identification register value, programming the card identification register value in a card, and generating a license in the card using the card identification register value, or a hash of the card identification register value, as part of a plaintext of the license in a secure signing process on the card. The license may be generated using the card having the card identification register value. Unique may mean one or less than one out of one hundred.

The approach may further incorporate storing the license on the card using the card identification register value.

The card may be removable from one computing device and insertable in another computing device. The license may be portable from one computing device to another computing device.

The card identification register value that is programmed in the card during the manufacture of the card may be necessarily unchangeable by a computing device that acts as a host for the card.

The card may be installable on any computing device that provides card support.

The license may be a securely signed license.

The license may be a software license.

The card may be a secure digital or software device card.

A card mechanism may incorporate a card having a card identification register value programmed in the card during a manufacture of the card. The card identification register value may be unique. A license may be generated using the card identification register value, or a hash of the card identification register value, as part of a plaintext of the license in a secure signing process of the license on the card.

The card may be a software device or secure digital (SD) card.

“Unique” may be one or less than one out of one hundred.

The card identification register value that is programmed in the card during the manufacture of the card may be unchangeable by a computing device that acts as a host for the card.

The card may be installable on virtually any computing device that provides support for the card.

The license may be stored on the card with the card identification register value.

The license may be a software license.

The license may be a securely signed license.

The card may be removable from one computing device and insertable in another computing device.

The license may be portable from one computing device to the other computing device.

The present system and/or approach might be associated with a Titan™ system.

U.S. patent application Ser. No. 11/839,889, filed Aug. 16, 2007, is hereby incorporated by reference. U.S. Pat. No. 8,484,454, issued Jul. 9, 2013, is hereby incorporated by reference. U.S. patent application Ser. No. 13/603,308, filed Sep. 4, 2012, is hereby incorporated by reference. U.S. patent application Ser. No. 14/327,451, filed Jul. 9, 2014, is hereby incorporated by reference.

Any publication or patent document noted herein is hereby incorporated by reference to the same extent as if each individual publication or patent document was specifically and individually indicated to be incorporated by reference.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A card system comprising:
a secure digital (SD) card having a unique card identification register value that is programmed into the SD card during a manufacturing of the secure digital card; and
a license stored on the SD card with the card identification register value; and
wherein:
the license is generated using the card identification register value, or a hash of the card identification register value, as part of a plaintext of the license in a secure signing process;
the license is a secure software license; and
unique is one or less than one out of one hundred.

2. The system of claim 1, wherein the SD card is removable from one computing device and installable in another computing device provided that the SD card is supported by the computing device.

3. The system of claim 1, wherein the card identification register value is virtually unchangeable by a computing device that is a host for the SD card.

4. The system of claim 3, wherein the license is portable from one computing device to another computing device.

5. A method for providing a card, comprising:
manufacturing a card;
generating a unique card identification register value;
programming the card identification register value in the card; and
generating a license in the card using the card identification register value, or a hash of the card identification register value, as part of a plaintext of the license in a secure signing process on the card; and
wherein:
the license is generated using the card having the card identification register value; and
unique is one or less than one out of one hundred.

6. The method of claim 5, further comprising storing the license on the card using the card identification register value.

7. The method of claim 5, wherein the card is removable from one computing device and insertable in another computing device.

8. The method of claim 7, wherein the license is portable from one computing device to another computing device.

9. The method of claim 5, wherein the card identification register value that is programmed in the card during the manufacture of the card is unchangeable by a computing device that acts as a host for the card.

10. The method of claim 5, wherein the card is installable on any computing device that provides card support.

11. The method of claim 5, wherein the license is a securely signed license.

12. The method of claim 5, wherein the license is a software license.

13. The method of claim 5, wherein the card is a secure digital or software device card.

14. A card mechanism comprising:
a card having a card identification register value programmed in the card during a manufacture of the card; and
wherein:
the card identification register value is unique; and
a license is generated using the card identification register value, or a hash of the card identification register value, as part of a plaintext of the license in a secure signing process of the license on the card.

15. The mechanism of claim 14, wherein the card is a software device or secure digital (SD) card.

16. The mechanism of claim 14, wherein unique is one or less than one out of one hundred.

17. The mechanism of claim 14, wherein the card identification register value that is programmed in the card during the manufacture of the card is unchangeable by a computing device that acts as a host for the card.

18. The mechanism of claim 14, wherein the card is installable on virtually any computing device that provides support for the card.

19. The mechanism of claim 14, wherein the license is stored on the card with the card identification register value.

20. The mechanism of claim 14, wherein the license is a software license.

21. The mechanism of claim 14, wherein the license is a securely signed license.

22. The mechanism of claim 15, wherein the card is removable from one computing device and insertable in another computing device.

23. The mechanism of claim 21, wherein the license is portable from one computing device to the other computing device.
